(19) United States
(12) Patent Application Publication
(10) Pub. No.: US 2009/0177921 A1
(43) Pub. Date: Jul. 9, 2009

(54) PORTABLE ELECTRONIC DEVICE AND CONTROL METHOD THEREOF

(75) Inventor: Ryouichi Kuriyama, Yokosuka-shi (JP)

Correspondence Address: PILLSBURY WINTHROP SHAW PITTMAN, LLP, P.O. BOX 10500, MCLEAN, VA, 22102, US

(73) Assignee: KABUSHIKI KAISHA TOSHIBA, Tokyo (JP)

(21) Appl. No.: 12/355,012

(22) Filed: Jan. 16, 2009

Related U.S. Application Data
(63) Continuation of application No. PCT/JP2007/063935, filed on Jul. 6, 2007.

(30) Foreign Application Priority Data
Jul. 19, 2006 (JP) 2006-197282

(51) Int. Cl. G06F 11/14

(52) U.S. Cl. 714/16; 714/E11.117

(57) ABSTRACT

A flag which is set to the on state when a process of writing data as a data file into a storage area which is permitted to be written only once results in failure is previously set in a data memory of an IC card. When a flag of a to-be-written EF specified by a write binary command is set to the on state, a control element of the IC card compares received data to be written to the EF with data which is already written to the data storage area of the EF. Based on the comparison result, the control element of the IC card rewrites data in the storage area in which the compared data items do not coincide with each other into the received data.

### CROSS REFERENCE TO RELATED APPLICATIONS

This is a Continuation application of PCT Application No. PCT/JP2007/063935, filed Jul. 6, 2007, which was published under PCT Article 21(2) in English.

This application is based upon and claims the benefit of priority from prior Japanese Patent Application No. 2006-197282, filed Jul. 19, 2006, the entire contents of which are incorporated herein by reference.

### BACKGROUND OF THE INVENTION

1. Field of the Invention

This invention relates to a portable electronic device such as an IC card which contains a module including a control element such as a CPU and a data programmable and rewritable nonvolatile memory, for example, and performs a process corresponding to a command input from the exterior and a control method of the portable electronic device.

2. Description of the Related Art

Recently, portable electronic devices such as IC cards are utilized for various applications. In the IC card, data such as image data with a large data amount (data with large data length) is stored in many cases. For example, in the IC card issued for personal use, face image data is written to the nonvolatile memory of the IC card as one personal information of the owner at the issuing processing time in many cases. Further, in some of the above IC cards, an area into which data can be written to the nonvolatile memory only once is provided. In the above area into which data can be written only once, data such as the personal information is written at the issuing processing time. Data such as image data with large data length is divided into plural portions and sequentially transmitted from the IC card processing device to the IC card. This is because it is difficult to transmit whole data with large data length by use of one command. For example, in some of the IC cards, the capacity of transmission/reception data is limited to 255 bytes. In such a case, received data items are sequentially written to the nonvolatile memory of the IC card. However, if the data writing operation is interrupted due to occurrence of a communication error or the like, the remaining data cannot be written to the nonvolatile memory of the IC card. This is because data cannot be written to the area of the nonvolatile memory into which data can be written only once if the whole area is not set to an unwritten state.

As the technique associated with the conventional IC card, the technique for setting the area into which data can be written only once into an unwritten state in response to a special initialization instruction supplied from the external device is described in Jpn. Pat. Appln. KOKAI Publication No. H10-214232. In this case, in the external device, it is necessary to supply an initialization instruction to a specified IC card to be initialized. The above process is considered necessary to manually identify an IC card to be initialized and manually perform the operation of supplying an initialization instruction to the IC card.

As another technique associated with the conventional IC card, the technique for writing data into a backup area in the data writing process and writing data which has been written to the backup area with reference to a writing identification flag when the data writing operation is interrupted is proposed in Jpn. Pat. Appln. KOKAI Publication No. 2002-229744. However, in the above technique, it is necessary to provide the backup area in the IC card and perform the process of writing data into the backup area.

### BRIEF SUMMARY OF THE INVENTION

An object of this invention is to provide a portable electronic device capable of performing a process of efficiently writing data into a memory and a control method of the portable electronic device.

According to an aspect of the present invention, there is provided a portable electronic device comprising a first memory which stores data, a second memory which stores identification information indicating whether the first memory is set to a state where data writing failure occurred, a determining section which determines whether the first memory is set to the state where data writing failure occurred based on the identification information when receiving a command which requests that data be written to the first memory, a write processing section which performs a process of writing data into the first memory according to the command when the determining section determines that the first memory is not set to the state where data writing failure occurred and a rewrite processing section which performs a process of rewriting data written to the first memory into data specified by the command when the determining section determines that the first memory is set to the state where data writing failure occurred.

According to another aspect of the present invention, there is provided a control method of a portable electronic device which is a control method used for the portable electronic device having a nonvolatile memory which stores data, comprising determining whether a data storage area of the nonvolatile memory is set to a state where data writing failure occurred based on identification information indicating whether the data storage area is set to the state where data writing failure occurred when a command which requests that data be written to the data storage area is supplied, performing a writing process of writing data into the data storage area according to the command when it is determined in the above determining step that the data storage area is not set to the state where data writing failure occurred, and performing a rewriting process of rewriting data written to the data storage area into data specified by the command when it is determined in the above determining step that the data storage area is set to the state where data writing failure occurred.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

FIG. 1 is a block diagram showing an example of the configuration of an IC card according to an embodiment of this invention and a system including the IC card.

FIG. 2 is a diagram showing an example of the structure of data stored in a data memory.

FIG. 3 is a diagram showing an example of the structure of EF definition information.

FIG. 4 is a diagram showing an example of the configuration of a write binary command.

FIG. 5 is a diagram showing an example of transmission data following after the write binary command shown in FIG. 4.

FIG. 6 is a flowchart for illustrating an example of a process for the write binary command.

FIG. 7 is a flowchart for illustrating a first example of a process performed when a flag of an EF specified as a to-be-written object by the write binary command is set to the on state.

FIG. 8 is a flowchart for illustrating a second example of the process performed when the flag of the EF specified as a to-be-written object by the write binary command is set to the on state.

### DETAILED DESCRIPTION OF THE INVENTION

There will now be described a best mode of an embodiment of this invention with reference to the accompanying drawings.

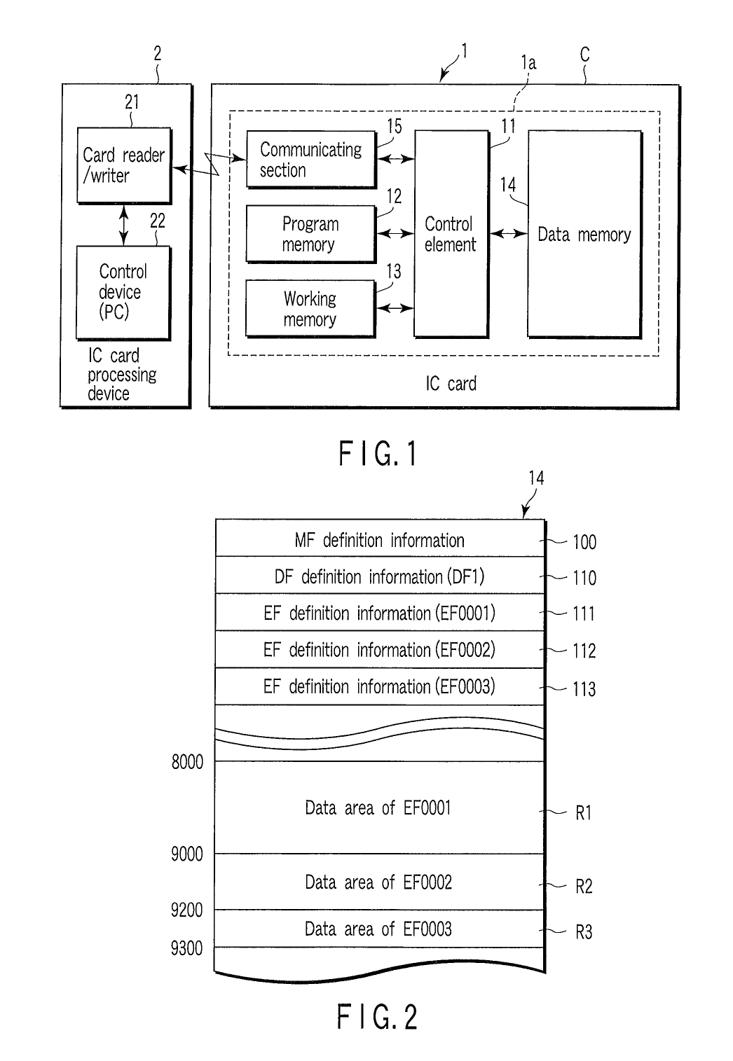

FIG. 1 is a block diagram showing an example of the configuration of an IC card 1 used as a portable electronic device according to an embodiment of this invention and an IC card system including the IC card 1.

The IC card 1 is set to an operable state when power is supplied thereto from an IC card processing device 2 as an external device. The IC card 1 set to the operable state performs various processes according to commands from the IC card processing device 2. The IC card processing device 2 supplies electric power to operate the IC card 1 and issues commands which request the IC card 1 to perform various processes.

The IC card 1 may be a contact type portable electronic device (contact IC card) which physically makes contact with the IC card processing device 2 to communicate therewith or a contactless type portable electronic device (contactless IC card) which makes radio communication with the IC card processing device 2 in a contactless state by use of an antenna, radio communicating section or the like. The contactless IC card and contact IC card are different only in the system of communication with the IC card processing device 2. Therefore, in the embodiment explained below, the explanation can be similarly applied to both cases of the contactless IC card and contact IC card.

First, an example of the configuration of the IC card 1 is explained.

As shown in FIG. 1, the IC card 1 includes a control element 11, program memory 12, working memory 13, data memory 14, communicating section (external interface) 15 and the like.

Further, the IC card 1 is configured by a card-like main body C. One (or a plurality of) IC chip 1a is embedded in the card-like main body C which configures the IC card 1. The IC chip 1a includes the control element 11, program memory 12, working memory 13, data memory 14, communicating section 15 and the like. For example, when the IC card 1 is a contactless IC card, the IC chip 1a is formed in a module form with an antenna for transmission/reception of radio waves connected thereto. The module is embedded in the card-like main body. Further, when the IC card 1 is a contact IC card, the IC chip 1a is formed in a module form while it is connected to a contact portion which physically makes contact with the external device. The module is embedded in the card-like main body with the contact portion exposed to the exterior.

The control element 11 is used to control the whole portion of the IC card 1. The control element 11 is operated based on a control program and control data stored in the program memory 12 or data memory 14. For example, the control element 11 performs a process according to a command supplied from the external device by executing the control program which controls the basic operation (a process according to a preset command).

The program memory 12 is configured by a read-only memory (ROM). In the program memory 12, a control program and control data used to control a basic operation (for example, a process for a preset command) are previously stored. In the program memory 12, a control program and control data corresponding to the specification of the IC card 1 are previously stored. The control element 11 realizes a process according to a command supplied from the exterior by use of the control program stored in the program memory 12.

The working memory 13 is configured by a volatile memory (RAM: random access memory). The working memory 13 functions as a buffer memory which temporarily stores data. For example, in the working memory 13, data transmitted or received in the communication process with the IC card processing device (external device) 2 is temporarily stored. Further, the working memory 13 is also used as a memory which temporarily stores various write data items.

The data memory (nonvolatile memory) 14 is a data writable nonvolatile memory. For example, the data memory 14 is configured by an EEPROM, flash memory or the like. In the data memory 14, various data items are stored by use of files with the structure defined by ISO/IEC7816 or the like. For example, in the data memory 14, a file (EF: Elementary File) as a data file managed by the structure (tree structure) formed of a plurality of hierarchies and a file (DF: Dedicated File) as a data folder are stored. In the DF, a processing program and operation data corresponding to purposes of applications are stored. Therefore, when the IC card 1 is used for a plurality of purposes of applications, a plurality of DFs corresponding to the respective purposes of applications are stored in the data memory 14. Further, in the area of the data memory 14, attributes are set based on definition information stored in the program memory 12 or the like. For example, an area (an area in which data can be written only once) of the data memory 14 which permits data to be written only once is defined by the above definition information.

The communicating section 15 makes data communication with the external device (for example, IC card processing device 2). For example, when the IC card is a contactless IC card, the communicating section 15 demodulates transmission data as received radio waves and supplies a demodulated signal to the control element 11. Further, when the IC card is a contactless IC card, the communicating section 15 modulates transmission data supplied from the control element 11 and transmits the modulated data as radio waves. Further, when the IC card is a contact IC card, the communicating section 15 transmits or receives data via a contact portion which physically makes contact with the external device.

The communicating section 15 receives electric power supplied from the external device. For example, in the contactless IC card, a power supply section (not shown) generates a clock pulse and power required for operating the respective portions of the IC card 1 based on radio waves received from the communicating section 15. Further, in the contact IC card, a clock pulse and power input via a contact portion (not shown) are supplied to the respective portions of the IC card 1.

Next, the IC card processing device 2 is explained.

As shown in FIG. 1, the IC card processing device 2 has a control device 21 and card reader/writer 22. The control device 21 is configured by a personal computer (PC) or the like. The control device 21 includes a processing section such as a CPU, various memories such as a RAM, ROM, nonvolatile memory and hard disc drive and various interfaces such as communication interfaces. In the control device 21, the processing section executes various control programs stored in the memory to perform various processes. Further, the control device 21 inputs or outputs data with respect to the card reader/writer 22 which makes data communication with the IC card 1.

For example, in the control device 21, control programs corresponding to various processes performed by use of the IC card 1 are previously stored. The control device 21 causes the IC card 1 to perform various processes by executing the above control programs. For example, the process of issuing the IC card 1 is performed by use of an issuing processing program. That is, in the IC card issuing process, the control device 21 supplies data to be written to the IC card 1 via the card reader/writer 22 according to a command which requests data writing at the issuing time in a preset procedure based on the issuing processing program.

The card reader/writer 22 functions as communicating means for making data communication with the IC card 1. The card reader/writer 22 makes data communication based on a communication system corresponding to the communication system of the IC card 1. That is, the control device 21 makes data communication with the IC card 1 via the card reader/writer 22.

When the IC card 1 is a contact IC card, the card reader/writer 22 is configured by a contact portion, communication control section and the like which physically make contact with the IC card 1 to make data communication. When the data transmission/reception operation with respect to the contact IC card is performed, the contact portion of the card reader/writer 22 physically makes contact with the contact portion provided on the IC card 1 side to make various data communications. Further, the card reader/writer 22 supplies a clock pulse and power to the IC card 1 via the contact portion which physically makes contact with the IC card 1.

When the IC card 1 is a contactless IC card, the card reader/writer 22 is configured by an antenna, communication control section (such as a modulation/demodulation circuit) and the like which make data communication with the IC card 1 by use of radio waves. When data is transmitted to the contactless IC card, the communication control section of the card reader/writer 22 modulates transmission data supplied from the control device 21 and transmits a modulated signal as radio waves from the antenna. Further, when data is received from the contactless IC card 1, the communication control section of the card reader/writer 22 demodulates the signal received as radio waves by the antenna and supplies the demodulated data as received data to the control device 21. The card reader/writer 22 performs the above data transmission/reception operation and transmits radio waves sued as a clock pulse and power to operate the IC card 1 from the antenna.

Next, the structure of data stored in the data memory 14 is explained.

As described above, data is stored as a data file (EF) in the data memory 14. For example, in ISO7816 which is a standard specification of the IC card, a transparent-structured (transparent) EF (binary EF), record-structured EF (record EF) and the like are defined as the structure of the data file (EF) stored in the data memory 14.

In the transparent EF, data (binary data) which is not structured is stored. Therefore, in the transparent EF, it is suitable to store data such as image data whose degree of freedom is high and which has large data length. The transparent EF is accessed by use of a binary-series command. In the record EF, a preset-form record containing management information and real data (record data) is stored as data. Therefore, in the record EF, data management can be easily performed. Data (record) stored in the record EF is accessed by use of a record-series command.

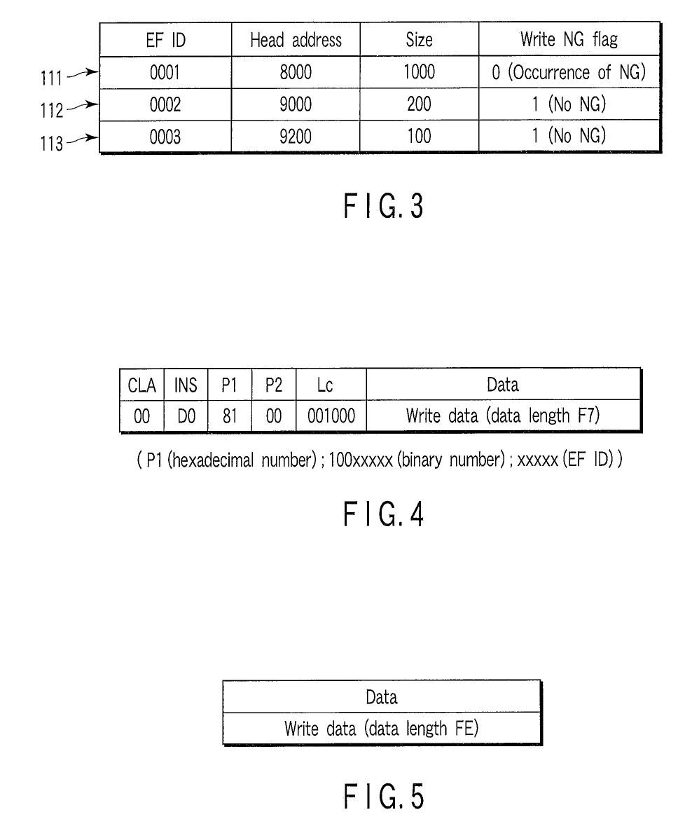

FIG. 2 is a diagram showing an example of the structure of data stored in the data memory (nonvolatile memory) 14. FIG. 3 is a diagram showing an example of the structure of EF definition information.

In the example of the structure shown in FIG. 2, master files (MF), DF (DF1), EF (EF0001, EF0002, EF0003) are defined. In MF definition information 100, information which defines MF is stored. In DF definition information 110, information which defines DF1 is stored. In storage areas (second storage means) of EF definition information items 111, 112, 113, information items which respectively define EF0001, EF0002, EF0003 are stored. Areas (first storage means) R1, R2, R3 are a data storage area (data area) to store data items as EF0001, EF0002, EF0003. In this case, it is supposed that EF0001, EF0002, EF0003 are binary EFs and are data files in which data is permitted to be written only once.

As shown in FIG. 3, the EF definition information items 111, 112, 113 each have “EF ID”, “head address”, “size” and “flag (write NG flag)”. The “EF ID” is identification information to identify an EF. The “head address” is information indicating the head address of the data storage area (data area) in which data of the EF is stored in the data memory 14. The “size” is information indicating the size (data length) of the EF.

Further, the “flag (write NG flag)” is information indicating whether a state where data writing into the data area of the EF failed is set or not. The “flag” is rewritten from an off state (“1” in this example) to an on state (“0” in this example) when data writing into the data area of the EF (binary EF) has failed. The “flag” rewriting procedure is explained in detail later. An area (an address at which an error has occurred) in which writing failure has occurred when the “flag” is set to the on state may be stored in the EF definition information. In this case, in the EF definition information, an area (address) in which data writing failure has occurred can be specified and the state indicating occurrence of data writing failure or the state where data writing failed can be determined according to the “flag”.

For example, in the example shown in FIG. 3, in the EF definition information 111, the “EF ID” is set to “0001”, the “head address” is set to “8000” and the “size” is set to “1000”. As shown in FIG. 2, this indicates that an area of “1000” bits from the address “8000” in the data memory 14, that is, an area of addresses “8000 to 8FFF” is defined to be a data area R1 of EF0001. Further, in the example shown in FIG. 3, in the EF definition information 111, the “flag (writing NG flag)” is set to “0 (occurrence of NG)”. This indicates the state where the process of writing data into the data area R1 of EF0001 has failed. In FIGS. 2, 3, 4 and 5, it is supposed that the numeric values are expressed by hexadecimal numbers.

In the example shown in FIG. 3, in the EF definition information 112, the “EF ID” is set to “0002”, the “head address” is set to “9000” and the “size” is set to “200”. As shown in FIG. 2, this indicates that an area of “200” bits from the address “9000” in the data memory 14, that is, an area of addresses “9000 to 91FF” is defined to be a data area R2 of EF0002. Further, in the example shown in FIG. 3, in the EF definition information 112, the “flag (writing NG flag)” is set to “1 (no NG)”. This indicates a state different from the state where the process of writing data into the data area R2 of EF0002 failed.

In the example shown in FIG. 3, in the EF definition information 113, the “EF ID” is set to “0003”, the “head address” is set to “9200” and the “size” is set to “100”. As shown in FIG. 2, this indicates that an area of “100” bits from the address “9200” in the data memory 14, that is, an area of addresses “9200 to 92FF” is defined to be a data area R3 of EF0003. Further, in the example shown in FIG. 3, in the EF definition information 113, the “flag (writing NG flag)” is set to “1 (no NG)”. This indicates a state different from the state where the process of writing data into the data area R3 of EF0003 failed.

Next, a command supplied to the IC card 1 is explained.

As described above, in the system shown in FIG. 1, the IC card 1 performs a process corresponding to a command supplied thereto from the IC card processing device 2. Various commands are provided as commands which can be executed by the IC card 1. For example, commands which issue a request of data writing or reading to the data memory 14 include a binary-series command and record-series command.

The binary-series command is mainly used to request a data writing process or reading process with respect to the binary EF. In the binary-series command, a host device specifies access to data in the EF by use of offset. On the other hand, the record-series command is mainly used to request a data writing process or reading process with respect to the record EF. In the record-series command, the host device specifies access to the record EF with respect to the IC card by use of information indicating the record.

Next, a write binary command which is used as one of the binary-series commands is explained.

FIG. 4 is a diagram showing an example of the configuration of the write binary command. FIG. 5 is a diagram showing an example of transmission data (command) following after the write binary command shown in FIG. 4.

The write binary command is a binary-series command which requests writing of data to the binary EF. As shown in FIG. 4, the write binary command includes information items such as a “CLA” portion, “INS” portion, “P1” portion, “P2” portion, “Lc” portion and “Data” portion. In the “CLA” portion and “INS” portion, information items indicating the types of commands are respectively stored. In the example shown in FIG. 4, in the “CLA” portion and “INS” portion, “00” and “D0” indicating the write binary command are respectively stored.

In the “P1” portion and “P2” portion, information items indicating processing parameters of the command are stored. Further, in the “P1” portion, information (information indicating EF ID) which specifies a file (EF) into which data is to be written is stored. In the example shown in FIG. 4, “81 (hexadecimal number)=10000001 (binary number)” is stored in the “P1” portion. In the example shown in FIG. 4, it is supposed that the lower five digits of the binary number of the value in the “P1” portion indicates identification information (EF ID) of the EF. That is, in the example shown in FIG. 4, “00001” is specified as the EFID in the “P1” portion.

In the “P2” portion, an offset value is stored as information indicating a data writing position (address) in the EF specified by the “P1” portion. In the example shown in FIG. 4, “00” is stored as information indicating an offset value in EF0001 specified by the “P1” portion. That is, in the example shown in FIG. 4, EFID is set to “00001” and the offset value is set to “0”. Therefore, in the write binary command shown in FIG. 4, the head address of EF0001 is specified as a data write start position in the “P1” portion and “P2” portion.

Further, in the “Lc” portion, information indicating the length of whole data to be written as binary data is stored. In the “Data” portion, data of the first portion among the data to be written is stored. In the “Data” portion, data up to the preset length is stored. That is, all of data items with the length specified by the “Lc” portion are not necessarily stored in the “Data” portion. If the length of whole data to be written as binary data is excessively large so that the whole data cannot be stored in the “Data” portion, data of the first portion of the data to be written is stored in the “Data” portion.

For example, in the example shown in FIG. 4, “001000” is specified as the data length in the “Lc” portion. This indicates that the data length of the whole binary data to be written is “1000”. Further, in the “Data” portion, data with the data length of “F7” is stored. In this example, it is supposed that the data length of data which can be stored in the “Data” portion is “F7”. In this case, as shown in FIG. 4, only data with the data length up to “F7” from the head portion of the whole binary data to be written is stored in the “Data” portion of the write binary command.

Therefore, it is necessary to supply the remaining data of “F09” among the binary data to be written to the IC card separately from the write binary command. For this purpose, in the write binary command, the remaining data (binary data) which cannot be stored in the “Data” portion of the command can be continuously supplied to the IC card. In this example, it is supposed that data items with the data length of “FE” are sequentially transmitted following after the write binary command. FIG. 5 is a diagram showing an example of data (command) to be transmitted following after the write binary command shown in FIG. 4. The whole portion of binary data to be written and specified by the write binary command shown in FIG. 4 is divided into data items with the data length of “FE” as shown in FIG. 5. The data items with the data length of “FE” are sequentially transmitted following after the write binary command.

That is, the binary data with large data length which cannot be stored in the “Data” portion of the write binary command is divided based on the preset data length and the thus divided data items are sequentially supplied following after the write binary command from the IC card processing device to the IC card. Thus, in the IC card, binary data items with the length specified by the “Lc” portion of the write binary command are sequentially received as the “Data” portion of the write binary command and transmission data following after the binary command. In this case, the IC card performs a process of writing the received data.

All of a plurality of data items sequentially supplied by use of the write binary command can be temporarily stored in a working memory if the working memory has large capacity. However, in a portable electronic device such as an IC card, it is difficult to provide a working memory with large capacity due to the physical limitation of the size of the device itself. Therefore, in the present embodiment, it is supposed that the IC card 1 writes part of received data into the data memory 14 and then receives data following after the written data. That is, in the present embodiment, it is assumed that at least part of data among a series of data items supplied by use of the write binary command is written and then the following data is received.

Next, the process for the write binary command in the IC card 1 is explained.

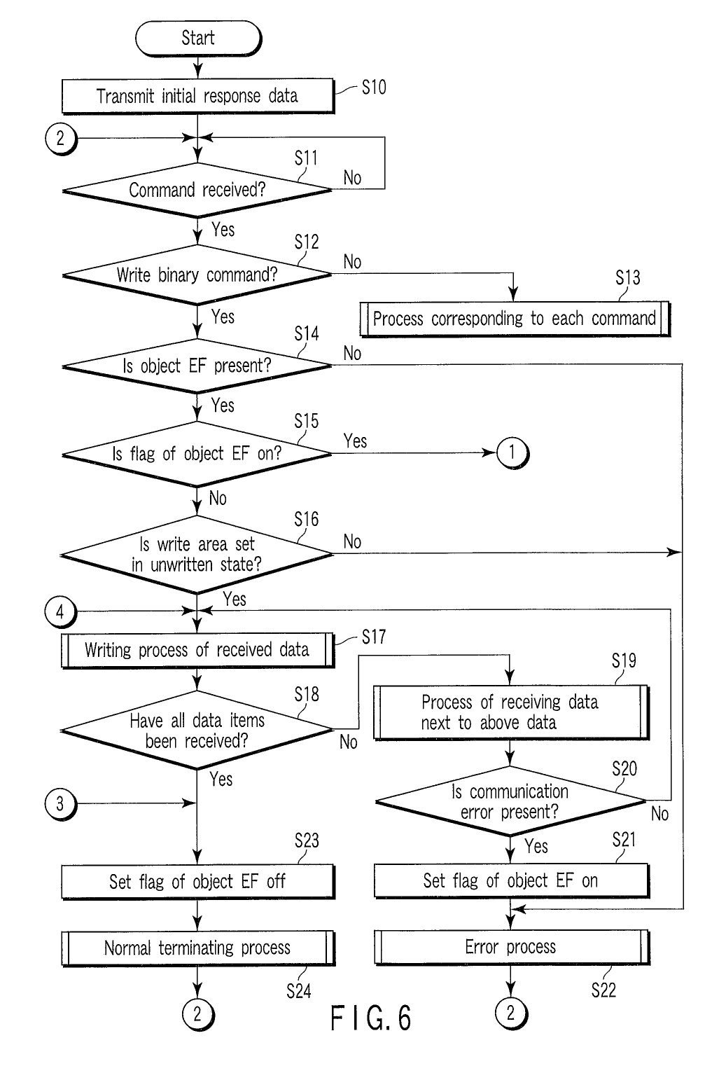

FIG. 6 is a flowchart for illustrating an example of the process for the write binary command. In the example shown in FIG. 6, it is assumed that binary data to be written to the data memory 14 specified by a write binary command is divided into a plurality of data items and supplied to the IC card 1. In this case, it is assumed that the process (the process of writing data into an area in which data can be written only once in the data memory 14) of issuing an IC card 1 is performed.

First, it is assumed that the IC card processing device 2 supplies a clock pulse and power to operate the IC card 1. When the clock pulse and power are supplied from the IC card processing device 2, the IC card 1 performs the start process and reset process. When the reset process is completed, the control element 11 of the IC card 1 transmits initial response data to the IC card processing device 2 as an initial response to the IC card processing device 2 (step S10). The IC card processing device 2 which has received the initial response data transmits a command to the IC card 1.

The IC card 1 which has transmitted the initial response data is set to a state in which it waits for a command from the IC card processing device 2. When, in this state, the command transmitted from the IC card processing device 2 is received by the communicating section 15 (“YES” in step S11), the control element 11 of the IC card 1 determines the type of the received command. The control element 11 of the IC card 1 determines the type of the command based on the values of the “CLA” portion and INS” portion of the received command.

When it is determined that the received command is a command other than the write binary command (“NO” in step S12), the control element 11 performs a process corresponding to the command (step S13). The relation between the commands and the values of the “CLA” portion and “INS” portion is previously stored in the program memory 12, for example. Further, processes corresponding to various commands are performed based on the programs previously stored in the program memory 12.

When it is determined that the received command is the write binary command (“YES” in step S12), the control element 11 of the IC card 1 determines a data file (binary EF) in which binary data is to be written based on the value of the “P1” portion as the process parameter in the write binary command (step S14). That is, the control element 11 of the IC card 1 retrieves definition information of the EF of EFID set in the “P1” portion of the received write binary command from the data memory 14. Based on the retrieving result, the control element 11 determines whether an EF specified as a to-be-written file by the write binary command is present or not.

If it is determined in the above determination step that the to-be-written EF (EF specified by the “P1” portion of the write binary command) is not present (“NO” in step S14), the control element 11 of the IC card 1 performs a preset error process (step S22). In this case, for example, the control element 11 performs a process of informing the IC card processing device 2 that the to-be-written EF specified by the write binary command is not present as the error process.

If it is determined in the above determination step that the to-be-written EF (EF specified by the “P1” portion of the write binary command) is present (“YES” in step S14), the control element 11 determines whether or not a flag (writing NG flag) with respect to the to-be-written EF is set to the on state (“0” in the example shown in FIG. 3) (step S15). That is, the control element 11 of the IC card 1 determines whether the flag (writing NG flag) is set to the on state (“0”) or off state (“1”) in definition information of the EF of EFID set in the “P1” portion of the write binary command. In this case, the control element 11 determines whether the flag of the EF specified as a to-be-written file by the write binary command is set to the on state or not.

If it is determined in the above determination step that the flag of the to-be-written EF (EF specified by the “P1” portion of the write binary command) is set to the on state (“YES” in step S15), the control element 11 of the IC card 1 performs a process which will be described later with respect to the EF set to the write error state (steps S31 to S38 or step S41). The process with respect to the EF set to the write error state will be described in detail later.

If it is determined in the above determination step that the flag of the to-be-written EF is not set to the on state, that is, the flag of the to-be-written EF is set to the off state (“NO” in step S15), the control element 11 determines whether the storage area (write area) of the to-be-written EF is set to an unwritten state or not (step S16). In this example, it is supposed that the to-be-written EF is an area in which data can be written only once. Further, it is supposed that whether or not the area is already written is determined according to whether the area is set to the unwritten state or not.

That is, the control element 11 of the IC card 1 determines whether the area (data storage area of the EF) specified by the EF definition information of EFID set in the “P1” portion of the received write binary command is set to an unwritten state or not. In this case, it is supposed that all of data items set to the unwritten state have values of “FF (all of the bits are “1”). Therefore, the control element 11 of the IC card 1 determines whether or not the area is set to the unwritten state according to whether all of the bits in the data storage area of the EF are set to the value of “1”.

If it is determined in the above determination step that the storage area of the to-be-written EF is not set to the unwritten state (“NO” in step S16), the control element 11 performs a preset error process (step S22). In this case, for example, the control element 11 performs a process of informing the IC card processing device 2 that the to-be-written EF specified by the write binary command is not set to the unwritten state as the error process.

In this case, it is confirmed in the preceding step S15 that the flag of the EF is set to the off state. Therefore, if it is determined in step S16 that the storage area is not set to the unwritten state, it is considered that the data storage area of the EF is set to a state in which data is written or faulty occurs in the memory or hardware. Therefore, in such a case, the control element 11 determines that the process for the write binary command cannot be performed and performs an error process.

If it is determined in the above determination step that the storage area of the to-be-written EF is set to the unwritten state (“YES” in step S16), the control element 11 performs a writing process corresponding to the write binary command (steps S17 to S20). First, when receiving the write binary command, the control element 11 performs a process of writing data stored in the “Data” portion of the write binary command from the head address specified by an offset value stored in the “P2” portion of the write binary command (step S17).

For example, when receiving the write binary command shown in FIG. 4, the control element 11 performs a process of writing data (data with the first data length of “F7” among the total data length of “1000”) stored in the “Data” portion from the head address “8000” of EF00001 in the data memory 14. When a write error occurs due to faulty in the hardware in the writing process of various data items in step S17, it is possible for the control element 11 to set the flag of the object EF into the on state and perform an error process.

When the writing process in step S17 is completed, the control element 11 determines whether or not the reception process and writing process of all of the data items are completed (step S18). The above determining process is performed by determining whether or not the process of writing data with data length (that is, binary data with whole data length) stored in the “Lc” portion is completed.

When it is determined in the above determining step that the reception process and writing process of all of the data items are not completed (“NO” in step S18), the control element 11 transmits a response indicating completion of the writing process of the received data to the IC card processing device 2 and is set to a wait state in which it waits for reception of next data (binary data). The IC card processing device 2 performs a process of transmitting next data (binary data) in response to the response indicating completion of the writing process from the IC card 1.

When next data is transmitted from the IC card processing device 2 in the data reception waiting state, the IC card 1 performs a reception process of receiving data by use of the communicating section 15 (step S19). In the reception process, the control element 11 of the IC card 1 determines whether or not data is correctly received (step S20).

If it is determined in the above determining step that data transmitted from the IC card processing device 2 is correctly received (“NO” in step S20), the control element 11 of the IC card 1 returns the process to step S17 and performs the process of writing received data. Thus, the control element 11 of the IC card 1 repeatedly performs the process of steps S17 to S20 until it is determined that reception of whole data specified by the write binary command is completed. Therefore, if an error such as a communication error does not occur, binary data divided into plural data items and supplied to the IC card 1 can be written to the data memory 14 according to a condition specified by the write binary command.

If it is determined in the above determining step that a communication error occurs in the data reception process, that is, if a communication error occurs in the course of reception of binary data (“YES” in step S20), the control element 11 sets the flag of the object EF into the on state (“0” in the example shown in FIG. 3) (step S21). For example, if next data cannot be received within a preset permissible period of time or if it is determined that received data is not correct by the parity check process, the control element 11 determines that a communication error has occurred. Further, when the flag of the object EF is set to the on state, the control element 11 of the IC card 1 performs a preset error process (step S22). In this case, for example, the control element 11 performs an error process such as a process of informing the IC card processing device 2 that the binary data writing process failure occurs due to a communication error.

If it is determined in step S18 that the reception process and writing process of all of the data items (binary data with data length specified by the “Lc” portion of the write binary command) are completed (“YES” in step S18), the control element 11 determines that all of the processes for the write binary command are correctly terminated. In this case, the control element 11 sets the flag in definition information of the EF specified by the write binary command into the off state (“1” in the example shown in FIG. 3) (step S23) and performs a normal terminating process (step S24). For example, the control element 11 performs a process of informing the IC card processing device 2 that the process of writing all of the data items specified by the write binary command has been completed as the above normal terminating process.

Next, an example of the process performed in a case where the flag of the to-be-written EF specified by the write binary command is set to the on state (when the to-be-written EF is set to the error state) is explained.

First, a first process example for the EF whose flag is set to the on state is explained.

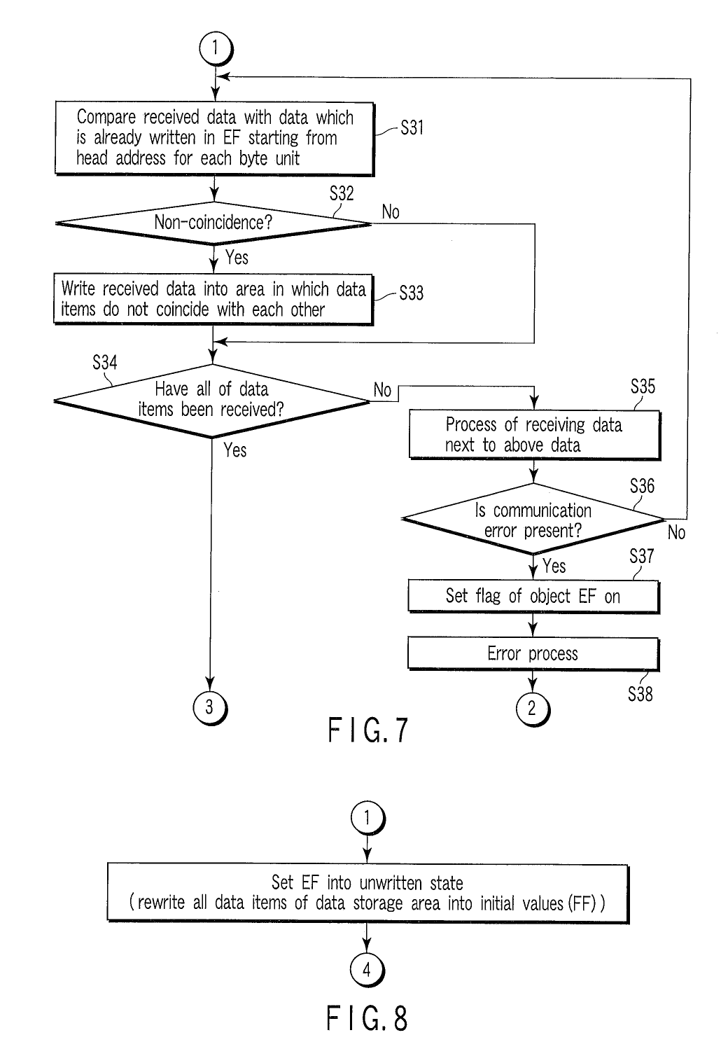

FIG. 7 is a flowchart for illustrating a first process example as a process (rewriting process) performed when the flag of the EF specified as a to-be-written object by the write binary command is set to the on state. That is, in the flowchart shown in FIG. 7, the first process example performed when it is determined in step S15 of FIG. 6 that the flag of the to-be-written EF is set to the on state is shown.

As described above, when receiving the write binary command, the control element 11 of the IC card 1 determines whether the flag of the EF specified by the “P1” portion of the write binary command is set to the on state or not. When it is determined in the above determination step that the flag of the to-be-written EF (EF specified by the “P1” portion of the write binary command) is set to the on state (“YES” in step S15), the control element 11 of the IC card 1 performs a rewriting process (first process example) for the EF set to the write error state as shown in FIG. 7 as the process for the EF set to the write error state (steps S31 to S38).

In the rewriting process for the EF set to the write error state, first, the control element 11 of the IC card 1 compares to-be-written data (received data) stored in the “Data” portion of the received write binary command with data (data which is already written) written to the to-be-written EF starting from the head address for each byte unit (step S31). By the comparison step, the control element 11 of the IC card 1 determines whether the received data coincides with the written data for each byte unit (step S32).

In this case, the unit with which the received data is compared with the written data can be adequately set. For example, the received data can be compared with the written data for each bit unit or for each plural-byte unit. In this example, it is supposed that the received data is compared with the written data for each byte unit.

If an area (an address in which an error has occurred) in which writing has failed is stored in the EF definition information and when it is determined in the above determining step that the received data does not coincide with the written data, then the control element 11 may be permitted to confirm that the area in which non-coincidence has occurred coincides with the area in which writing failure has occurred. In this case, it is possible to determine whether or not the area in which non-coincidence has occurred is an area in which erroneous data is stored due to writing failure.

When it is determined in the above determining step that the received data does not coincide with the written data (“NO” in step S32), the control element 11 performs a process of writing the received data for each byte in which both data items do not coincide (step S33). That is, received data is rewritten to an area in which the data does not coincide with the received data in the data storage area of the to-be-written EF. In this case, the received data is compared with the written data for each byte unit. Therefore, in step S33, the area of each byte unit in which data non-coincident with the received data is stored is rewritten based on the received data.

When data of the to-be-written area is rewritten to the received data in step S33 or when it is determined in the above determining step that the received data coincides with the written data (“NO” in step S31), the control element 11 of the IC card 1 determines whether the reception process and writing process of all of the data items are completed or not (step S34). Like the case of step S18, the above determining step is performed based on whether the reception process and writing process of data with data length stored in the “Lc” portion of the write binary command (that is, binary data of whole data length) are completed or not.

When it is determined in the above determining step that the reception process and writing process of all of the data items are not completed (“NO” in step S34), the control element 11 transmits a response indicating completion of the process of writing the received data to the IC card processing device 2 and is set to a wait state in which it waits for reception of next data (binary data). The IC card processing device 2 performs a process of transmitting next data (binary data) in response to the response indicating completion of the writing process from the IC card 1. When next data is transmitted from the IC card processing device 2 in the data reception waiting state, the IC card 1 performs a reception process of receiving data from the IC card processing device 2 by use of the communicating section 15 (step S35) like step S19 (step S35). Like step S20, in the reception process, the control element 11 of the IC card 1 determines whether or not data from the IC card processing device 2 is correctly received (step S36).

When it is determined in the above determining step that data from the IC card processing device 2 is correctly received (“NO” in step S36), the control element 11 of the IC card 1 returns the process to step S31. Thus, the control element 11 of the IC card 1 repeatedly performs the process of steps S31 to S36 until it is determined that reception of whole data specified by the write binary command is completed. Therefore, if an error such as a communication error does not occur, the IC card 1 can write binary data which is divided into a plurality of data items and supplied thereto following after the write binary command into the EF (which is not set to the unwritten state) set to the error state (in which the flag is set to the on state).

If it is determined in the above determining step that a communication error occurs in the data reception process, that is, if a communication error occurs in the course of reception of binary data (“YES” in step S36), the control element 11 sets the flag of the to-be-written EF into the on state (step S37) and performs a preset error process (step S38) like steps S21 and S22. In this case, the control element 11 performs a process of informing the IC card processing device 2 that the binary data writing process for the EF set to the error state due to a communication error as the error process, for example.

If it is determined in step S34 that the reception process and writing process of all of the data items (binary data with data length specified by the “Lc” portion of the write binary command) are completed (“YES” in step S34), the control element 11 determines that all of the processes for the write binary command are correctly terminated and carries on the process to step S23. In this case, the control element 11 sets the flag in definition information of the EF specified by the write binary command into the off state (step S23) and performs a normal terminating process (step S24).

As described above, in the first process example, the flag set to the on state when the data writing process for the data file in which the writing process is permitted only once has failed is previously provided. Then, when the flag of the to-be-written EF specified by the write binary command is set to the on state, the IC card 1 performs a process of comparing the received data to be written to the EF with data which is already written to the data storage area of the EF and rewriting the data in the storage area in which the compared data items do not coincide based on the received data.

Thus, even when data writing into the data area in which the writing process is permitted only once has failed due to a communication error or the like, the data writing process can be performed again. Particularly, when binary data with large data length is divided into plural data items so as to be written and the data items are transmitted to the IC card, the process of writing the data can be performed again even if a communication error occurs. As a result, in the card issuing process or the like, an IC card in which writing failure has occurred can be used again.

Next, a second process example for the EF having the flag set to the on state is explained.

FIG. 8 is a flowchart for illustrating the second example of the process performed when the flag of the EF specified as a to-be-written object by the write binary command is set to the on state. That is, in the flowchart shown in FIG. 8, the second process example performed when it is determined in step S15 of FIG. 6 that the flag of the to-be-written EF is set to the on state is shown.

As described above, when receiving a write binary command, the control element 11 of the IC card 1 determines whether or not the flag of the EF specified by the “P1” portion of the write binary command is set to the on state. If it is determined in the above determination step that the flag of the to-be-written EF (EF specified by the “P1 portion of the write binary command) is set to the on state (“YES” in step S15), the control element 11 of the IC card 1 performs a process (second process example) of setting the EF in the write error state shown in FIG. 8 into an unwritten state (step S41) as a process for the EF set to the write error state.

In the process of setting the EF in the write error state into the unwritten state, the control element 11 of the IC card 1 performs a process of entirely rewriting data in the data storage area of the EF specified as a to-be-written object by the received write binary command into initial values (for example, “FF”) (step S41). In this case, it is supposed that data items in the data storage area of the EF in the unwritten state are entirely set to “FF” (that is, all of the bits are set to “1”) as the initial values. Therefore, when all of the data items of the data storage area are rewritten to the initial values in step S41, it becomes possible to perform the process shown by the flowchart of FIG. 6. As a result, the control element 11 of the IC card 1 carries on the process to step S17 and performs the above process when all of the data items of the data storage area have been rewritten to the initial values in step S41.

As described above, in the second process example, the flag which is set to the on state when the process of writing data into the data file which is permitted to be written only once has failed is previously provided. Then, when the flag of the to-be-written EF specified by the write binary command is set to the on state, the control element 11 of the IC card 1 sets the EF into the unwritten state by rewriting all of the data items of the data storage area into the initial values and writes received data into the EF set to the unwritten state.

Thus, even when data writing into the data area which is permitted to be written only once has failed due to a communication error or the like, the process of writing the data can be performed again. Particularly, when binary data with large data length is divided and transmitted to the IC card in plural cycles so as to be written therein, the process of writing the data can be performed again even if a communication error occurs. As a result, in the card issuing process or the like, an IC card in which data writing has failed can be utilized again.

According to the above first or second process example, the IC card can determine the state of the to-be-written EF based on the state of the flag and perform the data writing process corresponding to the determined state if the IC card processing device supplies a write binary command again. Therefore, even if the IC card processing device does not supply a special command to a specified IC card, data can be written to the area which is permitted to be written only once and in which writing has failed due to a communication error or the like in the IC card. Further, even when a backup memory is not provided in the IC card, the data writing process corresponding to the state of the to-be-written EF can be performed in the IC card. As a result, according to this embodiment, an IC card in which an efficient data writing process can be performed can be provided.

As described above, in the IC card according to the present embodiment, the flag which is set to the on state when the process of writing data to the data file which is permitted to be written only once has failed is previously provided. When the flag of the to-be-written EF specified by the write binary command is set to the on state, the IC card 1 performs the process of comparing received data to be written to the EF with data already written to the data storage area of the EF and rewriting the storage area in which the compared data items do not coincide based on the received data.

Thus, the data writing process can be performed again even when data writing to the data area which is permitted to be written only once has failed due to a communication error or the like and an IC card which can be utilized again can be provided even if data writing has failed.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A portable electronic device comprising:
a first memory which stores data,
a second memory which stores identification information indicating whether the first memory is set to a state where data writing failed,
a determining section which determines whether the first memory is set to a state where data writing failure occurred based on the identification information when receiving a command which requests that data be written to the first memory,
a write processing section which performs a process of writing data into the first memory according to the command when the determining section determines that the first memory is not set to the state where data writing failure occurred, and
a rewrite processing section which performs a process of rewriting data written to the first memory into data specified by the command when the determining section determines that the first memory is set to the state where data writing failure occurred.

2. The device according to claim 1, further comprising a first setting section which sets the identification information to information indicating that the first memory is set to the state where data writing failure occurred when the data writing process by the write processing section has failed, and a second setting section which sets the identification information to information indicating that the first memory is not set to the state where data writing failure occurred when the data rewriting process by the rewrite processing section is successfully performed.

3. The device according to claim 1, further comprising a determining section which determines whether the first memory is set to an unwritten state when the determining section determines that the first memory is not set to a state where data writing failure occurred, and an error processing section which inhibits data from being written to the first memory when the determining section determines that the first memory is not set to a state where data writing failure occurred and the determining section determines that the first memory is not set to the unwritten state, wherein the write processing section performs a process of writing data into the first memory according to the command when the determining section determines that the first memory is not set to a state where data writing failure occurred and the determining section determines that the first memory is set to the unwritten state.

4. The device according to claim 1, wherein the determining section determines whether the first memory is set to the state where data writing failure occurred based on the identification information when receiving a command which requests that data divided and supplied thereto in plural cycles be written to the first memory, and the write processing section performs a process of sequentially writing received data into the first memory each time part of data which is requested to be written to the first memory by the command when the determining section determines that the identification information indicates the state where writing failure occurred.

5. The device according to claim 1, wherein the rewrite processing section performs a process of determining whether received data requested to be written to the first memory by the command coincides with data written to an area into which the received data is to be written to the first memory and rewriting data in the area which does not coincide with the received data into the received data.

6. The device according to claim 4, wherein the rewrite processing section performs a process of determining whether received data coincides with data written to an area into which the received data is to be written to the first memory each time part of data requested to be written to the first memory by the command is received and rewriting data in the area which does not coincide with the received data into the received data.

7. The device according to claim 1, wherein the rewrite processing section rewrites the first memory into an unwritten state and causes the write processing section to perform a data writing process with respect to the first memory which is rewritten to the unwritten state.

8. The device according to claim 1, further comprising a module containing the first memory, second memory, determining section, write processing section and rewrite processing section, and a main body having the module embedded therein.

9. A control method used for a portable electronic device having a nonvolatile memory which stores data, comprising:
determining whether a data storage area of the nonvolatile memory is set to a state where data writing failure occurred based on identification information indicating whether the data storage area is set to the state where data writing failure occurred when a command which requests that data be written to the data storage area,
performing a writing process of writing data into the data storage area according to the command when it is determined in the above determining step that the data storage area is not set to the state where data writing failure occurred, and
performing a rewriting process of rewriting data written to the data storage area into data specified by the command when it is determined in the above determining step that the data storage area is set to the state where data writing failure occurred.

10. The method according to claim 9, further comprising setting the identification information to information indicating that the data storage area is set to a state where data writing failure occurred when the data writing process has failed, and setting the identification information to information indicating that the data storage area is not set to the state where data writing failure occurred when the data rewriting process is successfully performed.

11. The method according to claim 9, further comprising confirming whether the data storage area is set to an unwritten state when it is determined in the above determining step that the data storage area is not set to a state where data writing failure occurred, and inhibiting data from being written to the data storage area when it is determined in the above determining step that the data storage area is not set to the state where data writing failure occurred and it is confirmed in the above confirming step that the data storage area is not set to the unwritten state, wherein the performing the writing process performs a process of writing data into the data storage area according to the command when it is determined in the above determining step that the data storage area is not set to the state where data writing failure occurred and it is confirmed in the above confirming step that the data storage area is set to the unwritten state.

12. The method according to claim 9, wherein the determining determines whether the data storage area is set to the state where data writing failure occurred based on the identification information when receiving a command which requests that data divided and supplied thereto in plural cycles be written to the data storage area, and the performing the writing process writes received data into the data storage area each time part of data which is requested to be written to the data storage area by the command when it is determined in the above determining step that the identification information indicates the state where writing failure occurred.

13. The method according to claim 9, wherein the performing the rewriting process determines whether received data requested to be written to the data storage area by the command coincides with data written to an area into which the received data is to be written to the data storage area and rewrites data in the area which does not coincide with the received data into the received data.

14. The method according to claim 12, wherein the performing the rewriting process determines whether received data coincides with data written to an area into which the received data is to be written to the data storage area each time part of data requested to be written to the data storage area by the command is received and rewrites data in the area which does not coincide with the received data into the received data.

15. The method according to claim 9, wherein the performing the rewriting process rewrites the data storage area into an unwritten state and writes data into the data storage area which is rewritten to the unwritten state by use of the writing process.
